(19) United States
(12) Patent Application Publication
(10) Pub. No.: US 2026/0200049 A1
(43) Pub. Date: Jul. 16, 2026

(54) CONTROLLED SPEED WRENCH AND CONTROL METHOD

(71) Applicant: CEMBRE S.P.A, Brescia (IT)

(72) Inventors: Gualtiero BAREZZANI, Brescia (IT); Davide NICOLAI, Brescia (IT); Michele ORIZIO, Brescia (IT); Samuel VEGLIANTI, Brescia (IT)

(21) Appl. No.: 19/134,702

(22) PCT Filed: Dec. 14, 2023
(86) PCT No.: PCT/IB2023/062663

§ 371 Date: May 30, 2025

(30) Foreign Application Priority Data
Feb. 17, 2023 (IT) 102023000002775

(51) Int. Cl. B25B 21/00

(52) U.S. Cl. CPC B25B 21/002

(57) ABSTRACT

A method for controlling a wrench (1) includes the steps of providing a calibration association between a screwing torque (M) and a corresponding electric current (I) absorbed by a motor (3) of the wrench (1), selecting a rotation direction of a tool holder shaft (2) of the wrench (1), actuating a motor (3) of the wrench (1), detecting an instantaneous current (I_inst) of the motor (3) during its operation, controlling the power supply of the electric motor (3) depending on the selected rotation direction, a target torque screwing value (M_tgt), the detected instantaneous current (I_inst), and the calibration association, and if the selected rotation direction is a screwing direction, when the detected instantaneous current (I_inst) reaches or exceeds a target current value (I_tgt) corresponding to the target torque value (M_tgt) according to the calibration association, deactivating and/or stopping the motor (3), changing a rotation speed (RPM) of the motor (3) depending on the detected instantaneous current (I_inst), and in a final screwing step in which the detected instantaneous current (I_inst) increases until it reaches the target current value (I_tgt), reducing the rotation speed (RPM) of the motor (3) to a final speed value (RPM_final) lower than an initial speed value (RPM_init) in an initial screwing step.

The present invention relates to a controlled speed portable wrench, with electric motor and battery and/or powerable by a wire connection, in particular for operations of screwing and unscrewing bolts, nuts and screws to rails and sleepers in the construction and maintenance of railway lines, for example for screwing and unscrewing so-called “connectors” to the sleepers, which connectors in turn hold the rails tight against the sleeper.

There are known wrenches having a motor for generating a rotary motion, an actuation switch for actuating the motor, a tool holder shaft, a reducer connected between the motor and the tool holder shaft so as to transmit and demultiply the rotary motion from the motor to the tool holder shaft and to rotate the tool holder shaft, an electronic control system connected to a source of electricity and the actuation switch, as well as a handle structure for manually gripping the wrench.

In railway constructions, two main applications are identifiable:
The creation of the joints of the rails by perforated plates arranged on both sides of the perforated web of two adjoining rails and screwed by means of horizontal bolts, so as to form the continuous iron surface.
The anchoring of the rail connectors to sleepers by vertical screws. Such an application requires approximately vertical screwing or unscrewing from the top.

A typical screwing of a threaded joint has a first more or less lengthy screwing step in which the head of the screw or nut is brought close to the abutment, and a second true tightening step in which occurs the torque tightening of the screw or nut against the abutment. Similarly, unscrewing a threaded joint has a first loosening step of the tightening between the screw or nut and the abutment, and a second more or less lengthy step for the complete separation of the two threaded members from each other.

The tightening and loosening steps of the tightening require high torques obtainable, for example, by a significant multiplication of the torque, which results in a proportional reduction of rotation speed. Contrarily, the approaching and removing steps of the threaded member with respect to the abutment can be performed with low torques and higher speeds, obtainable by a low torque multiplication with proportional increase in the screwing/unscrewing speed.

In this respect, the wrench reducer of the prior art is switchable between a first configuration (hereinafter “fast gear”) in which the screwing speed is high and the screwing torque is low, and a second configuration (hereinafter “slow gear”) in which the screwing speed is low and the screwing torque is high. The switching occurs, for example, by engaging or disengaging one or more reduction stages depending on the deformation state of an elastic spring connected to the reducer.

This known switching solution is mechanically complex, costly to manufacture and assemble, difficult to calibrate accurately, not synchronisable with a possible electronic control of the motor, and not directly influenceable or monitorable by an electronic control system of the wrench.

This prevents, for example, an easy adjustment or setting of the resistant torque value at which the reducer switching between the fast gear and low gear is to occur. Moreover, in the prior art, the separation of the reducer switching from the screwing torque control and motor control can, under certain circumstances, lead to operation interruptions and anomaly signals due only to the lack of coordination of the control of all the wrench functions by a single control system and process.

Lastly, the gear change mechanism involves increased axial and radial encumbrance of the reducer with respect to reducers without gear change.

On the other hand, in wrenches without speed change, the electric motor is to be sized to provide both the desired screwing speed and the maximum torque required to complete the tightening of the threaded connection.

Moreover, it has been observed in controlled torque wrenches and with substantially constant motor rotation speed that when the motor is deactivated when the target screwing torque is reached, undesired inertial effects due to all the masses in rotation (motor rotor, reducer gears, tool holder shaft) occur which cause an undesired excess of screwing torque with respect to the planned target torque. This undesired phenomenon is more pronounced in wrenches without gear change, but it occurs (to a lesser measure) also in certain wrenches with gear change depending on the rotary speeds of the masses of the wrench which are decelerated when the motor stops.

Therefore, it is the object of the present invention to provide an improved controlled torque wrench having features such as to overcome at least some of the drawbacks mentioned with reference to the prior art.

It is a particular object of the invention to reduce undesired inertial effects which can cause an excess screwing torque with respect to the planned target screwing torque.

It is a further particular object of the invention to coordinate the control of the screwing speed with the instantaneous screwing torque by means of the electronic control system of the wrench alone.

It is an even further particular object of the invention to coordinate the control of reaching the target screwing torque with the speed control of the motor by means of a single electronic control process in order to increase the screwing reliability and accuracy as well as the safety of the wrench.

It is a further particular object of the invention to provide a controlled torque and controlled speed wrench, in particular for railway use, having features such as to reduce the mechanical complexity of the reducer and eliminate the calibration difficulties of the switchable torque value observable in the prior art.

At least some of the objects listed above are achieved by a controlled torque and controlled speed wrench according to claim 1, as well as by a control method according to claim 16. The dependent claims relate to preferred and advantageous embodiments. Some of the objects of the invention are subordinate to others or even independent of others. Some of the embodiments of the dependent claims achieve single or multiple objects in a synergistic or independent manner.

In order to better understand the invention and appreciate the advantages thereof, some non-limiting exemplary embodiments will be described below with reference to the drawings, in which:

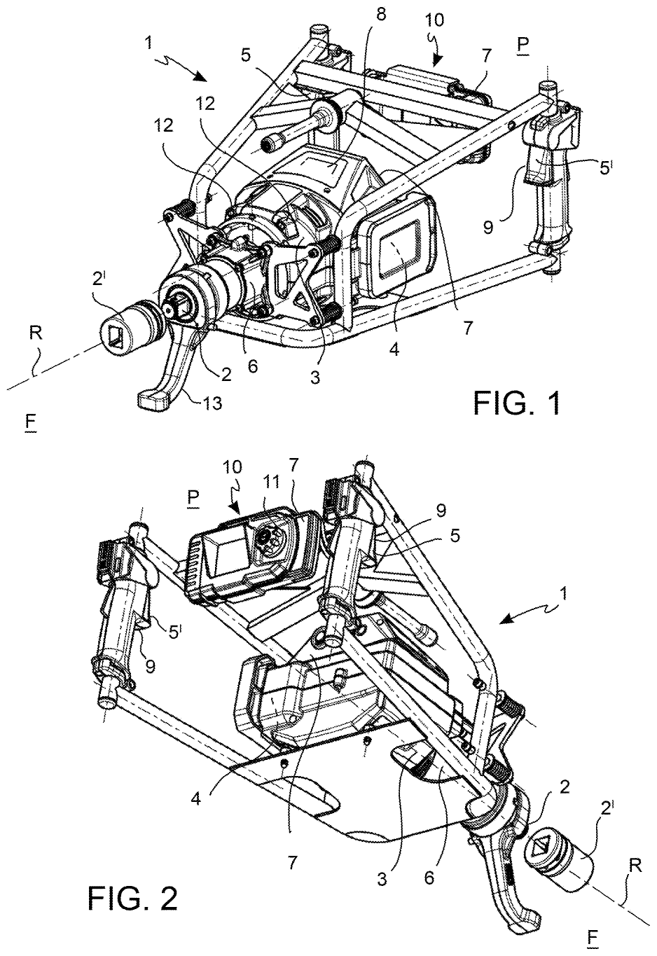

FIGS. 1 and 2 are perspective views of a wrench according to an embodiment;

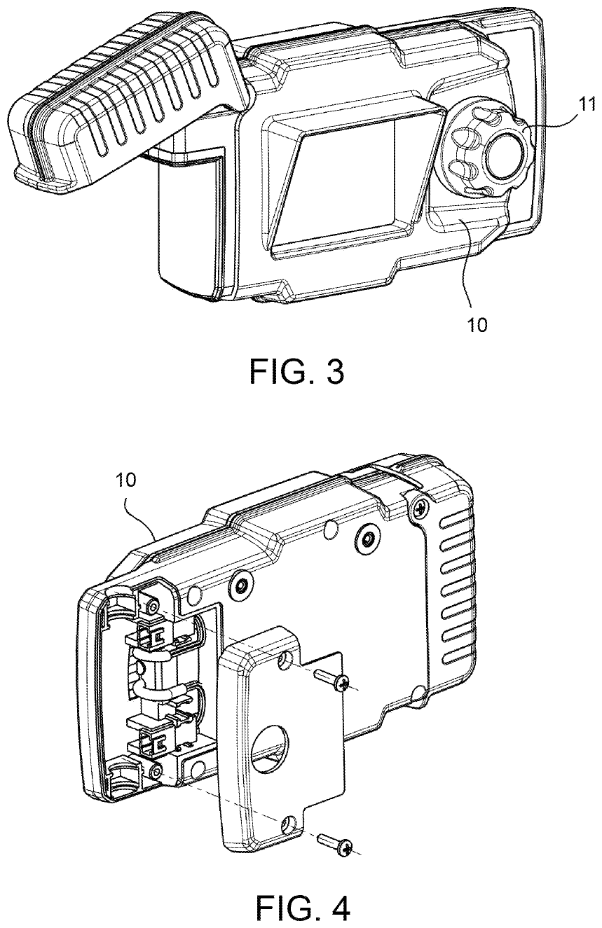

FIG. 3 is a rear perspective view of a control and display module of the wrench according to an embodiment,

FIG. 4 is a front perspective view of the control and display module in FIG. 3,

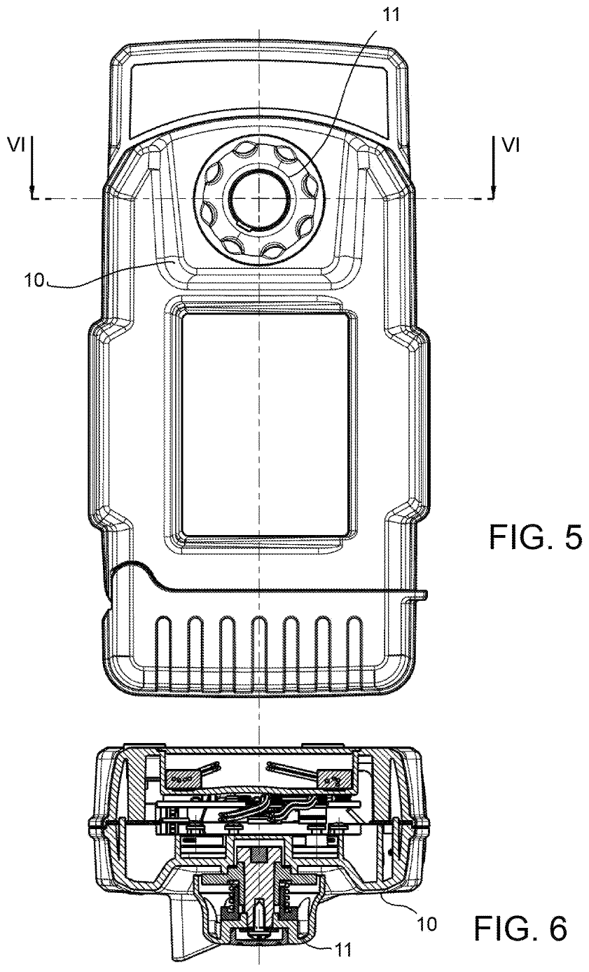

FIG. 5 is a rear view of the control and display module in FIG. 3,

FIG. 6 is a sectional view according to the cross-section plane VI-VI in FIG. 5,

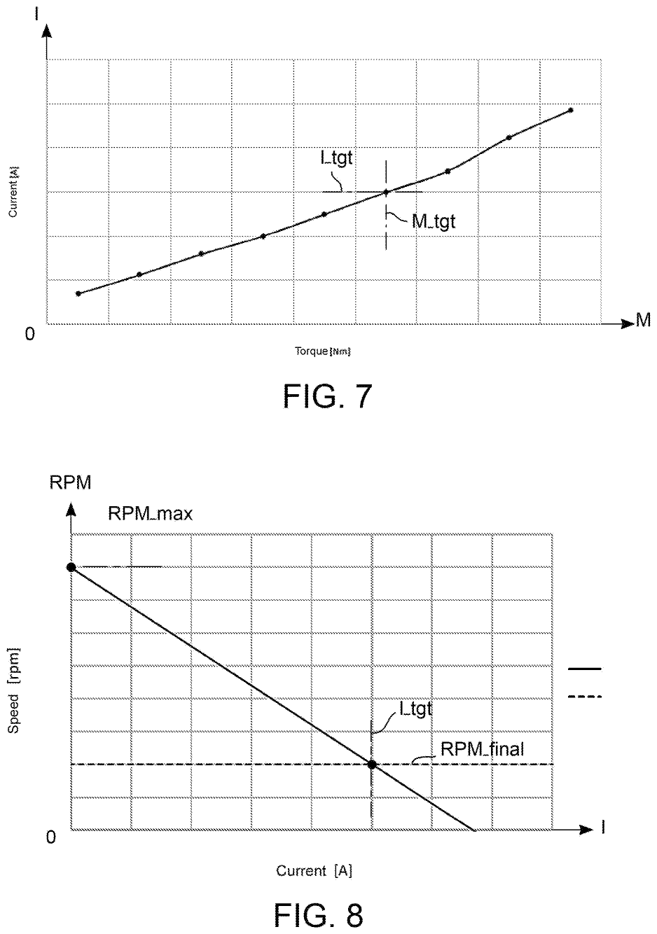

FIG. 7 shows a calibration curve of the electric current I [ordinates] absorbed by the wrench motor according to the torque M [abscissas] transmitted by the wrench to a screw according to an embodiment,

FIG. 8 shows a control function of the rotation speed RPM [ordinates] of the wrench motor according to the electric current I [abscissas] absorbed by the wrench motor, according to an embodiment,

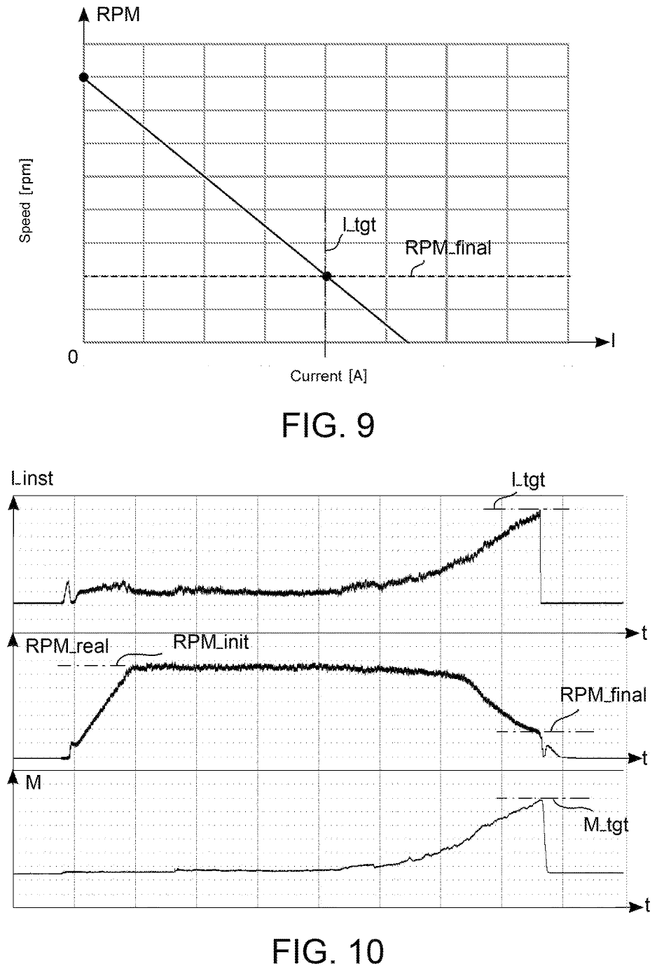

FIG. 9 shows a control function of the rotation speed RPM [ordinates] of the wrench motor according to the electric current I [abscissas] absorbed by the wrench motor, according to a further embodiment,

FIG. 10 shows, in order from the top down, the trend of the electric current I absorbed by the motor, the rotation speed RPM of the motor, the torque M transmitted by the wrench to the screw, according to time t, which are detected in a wrench according to the invention controlled by the linear control function,

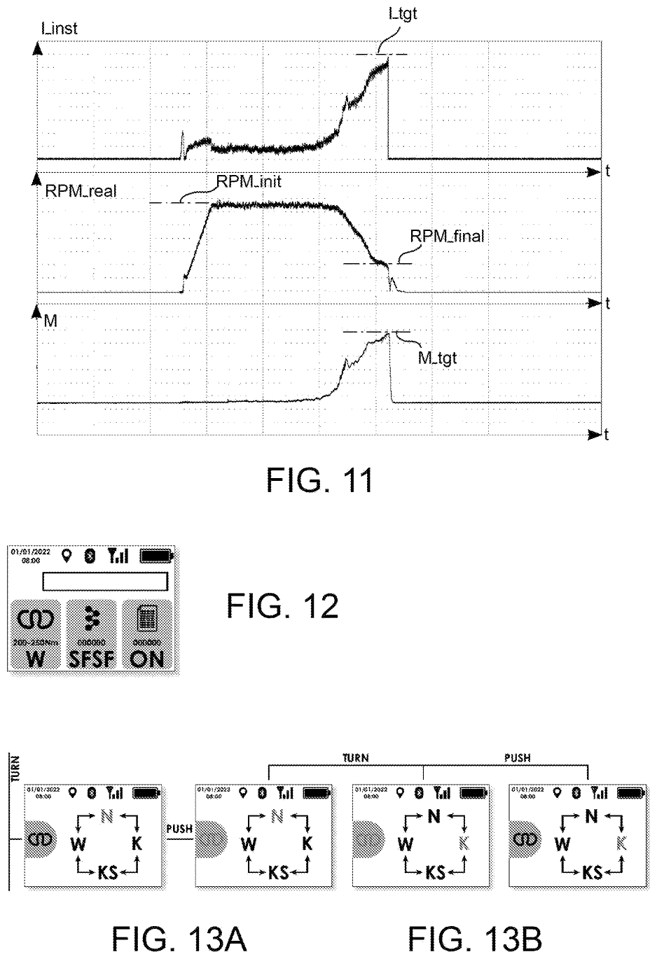

FIG. 11 shows, in order from the top down, the trend of the electric current I absorbed by the motor, the rotation speed RPM of the motor, the torque M transmitted by the wrench to the screw, according to time t, which are detected in a wrench according to the invention controlled by the same control function in FIG. 10, but which screws a different rail connector,

FIG. 12 shows a default visualization of a display of a user interface of the wrench according to an embodiment,

FIG. 13A shows a visualization by a display of types of rail connectors to be screwed,

FIG. 13B shows a value selection of rail connector type,

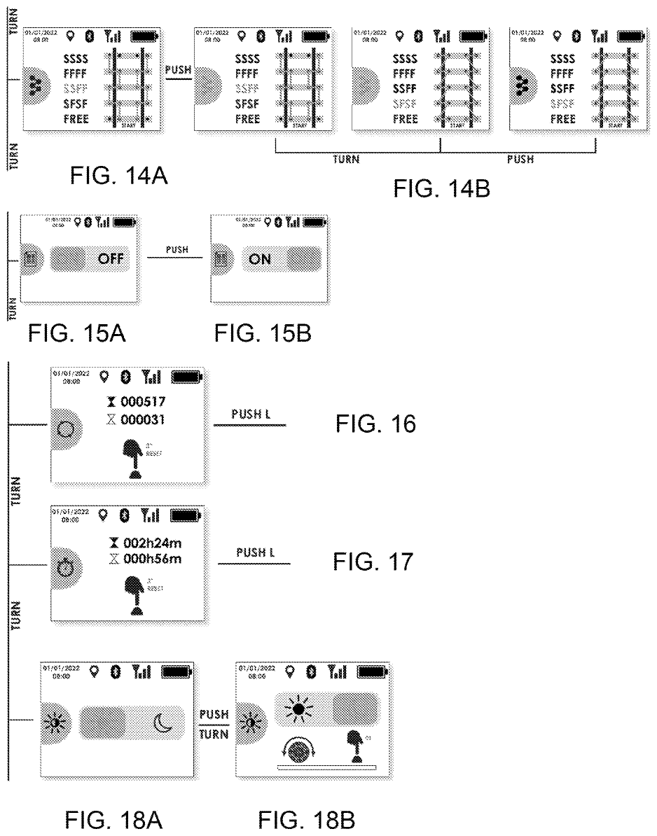

FIG. 14A shows a visualization by a display of screwing sequence,

FIG. 14B shows a value selection of screwing sequence,

FIG. 15A shows a visualization by a display of a function for generating a screwing operation log file,

FIG. 15B shows a selection for disabling log file generation,

FIG. 16 shows a visualization by a display of a total number of screwing/unscrewing operations performed and a partial number of screwing/unscrewing operations performed starting from a reset to be performed by the user,

FIG. 17 shows a visualization by a display of total use time and partial use time starting from a reset to be performed by the user,

FIG. 18A shows a visualization by a display of an adjustment of the display brightness,

FIG. 18B shows a selection of display brightness value or intensity,

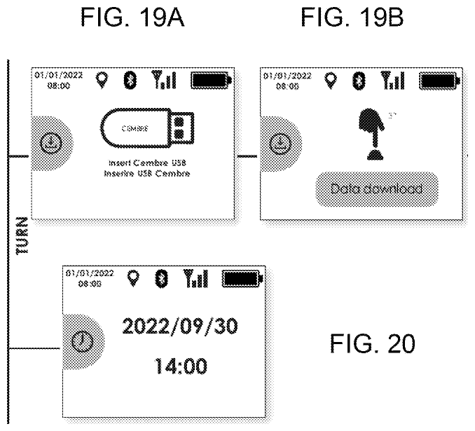

FIG. 19A shows a visualization by a display of a data download function onto external memory support,

FIG. 19B shows a data download activation selection onto external memory support,

FIG. 20 shows a visualization by a display and adjustment of date and time.

### Description of Wrench 1

With reference to the drawings, a wrench 1 includes a tool holder shaft 2 adapted to support a bushing 2′ or similar tools for engaging the nuts or heads of the screws to be screwed, unscrewed. The tool holder shaft 2 is arranged on a front side F of wrench 1 and rotatably supported about a rotation axis R. An electric motor 3, preferably a brushless motor, for example a 36 Volt three-phase brushless motor, powered by one or more (rechargeable) electric batteries 4, for example a 36 Volt, 6.2 Ah or 8 Ah rechargeable battery, can be arranged in a central region or on a rear side P of wrench 1, opposite to the front side F, and is adapted to generate the rotary motion and the torque required for the screwing/unscrewing operations.

Wrench 1 further includes a reducer 6 connected between motor 3 and the tool holder shaft 2. Reducer 6 interacts with motor 3 and with the tool holder shaft 2 so as to transmit the rotary motion (transforming the angular speed and torque thereof) from motor 3 to the tool holder shaft 2 to rotate the tool holder shaft 2 about the rotation axis R.

Wrench 1 further includes an electronic control system 7 connected to the at least one electric battery 4 and the electric motor 3.

The electronic control system 7 includes:
an actuation 5, 5′ and direction selection 9 device for actuating motor 3 and the selection of the rotation direction (screwing or unscrewing), for example including one or more button or trigger actuation switches and/or a two-stable position direction selection switch, and/or where the direction selection function is implemented by the actuation device 5, 5′ itself, for example by a manual screwing actuation member 5 and a manual unscrewing actuation member 5′, and/or where the actuation of motor 3 occurs automatically in response to a predefined push support of wrench 1 (by the bushing 2′) on the head of a screw,
a memory 8 in which a calibration association between the unscrewing/screwing torque M (intended as “working” torque) of wrench 1 and a corresponding electric current I absorbed by motor 3, for example a calibration function or a calibration table with pairs of value (torque M, current I), is stored.

The electronic control system 7 is configured for:
detecting an instantaneous current I_inst of motor 3 during its operation,
detecting an actuation state of the actuation and direction selection device 5, 5′, 9,
controlling the power supply of the electric motor 3 depending on the detected actuation state, the selected rotation direction, a target torque screwing value M_tgt, the detected instantaneous current I_inst, and the stored calibration association,
if the selected rotation direction is a screwing direction:
   when the detected instantaneous current I_inst reaches or exceeds a target current value I_tgt corresponding to the target torque value M_tgt according to the calibration association, deactivating and/or stopping motor 3,
   changing a rotation speed RPM of motor 3 depending on the detected instantaneous current I_inst, and
   in an initial screwing step, adjusting the rotation speed RPM of motor 3 to an initial speed value RPM_init,
   in a final screwing step in which the detected instantaneous current I_inst increases until it reaches the target current value I_tgt, reducing the rotation speed RPM of motor 3 to a final speed value RPM_final lower than the initial speed value RPM_init.

Wrench 1 thus configured exploits the instantaneous current I_inst absorbed by motor 3 as indicator of torque M applied by wrench 1 and achieves high initial screwing speeds in the initial screwing step at relatively low torsional resistance, as well as slows the screwing speed as the instant in which the target screwing torque M_tgt is achieved and the motor is stopped, approaches.

This reconciles the need for screwing as quickly as possible with the need to reduce undesired inertial effects when the motor stops which otherwise would cause an undesired excess of screwing torque with respect to the planned target torque M_tgt.

The screwing speed control according to the invention can be implemented in a merely electronic manner without the need to perform an active control of the reducer, for example a switching gear, thus reducing the mechanical complexity of the reducer and eliminating the calibration difficulties of the switching torque value observable in the prior art.

The suggested wrench further allows coordinating the control of the screwing speed with the instantaneous screwing torque by means of the electronic control system alone.

The suggested wrench further allows coordinating the control for reaching the target screwing torque M_tgt with adjustment of the motor speed RPM by a single electronic control process, thus increasing the screwing reliability and accuracy as well as the safety of the wrench.

### Description of the Control Method

Similarly, a method for controlling a wrench 1 includes the steps:
providing a calibration association between the unscrewing/screwing torque M (intended as “working” torque) of wrench 1 and a corresponding electric current I absorbed by a motor 3 of wrench 1, for example a calibration function or a calibration table with pairs of value (torque M, current I),
selecting a (screwing or unscrewing) rotation direction of wrench 1,
actuating a motor 3 of wrench 1,
detecting an instantaneous current I_inst of motor 3 during its operation,
controlling the power supply of the electric motor 3 depending on the selected rotation direction, a target torque screwing value M_tgt, the detected instantaneous current I_inst, and the calibration association,
if the selected rotation direction is a screwing direction:
   when the detected instantaneous current I_inst reaches or exceeds a target current value I_tgt corresponding to the target torque value M_tgt according to the calibration association, deactivating and/or stopping motor 3,
   changing a rotation speed RPM of motor 3 depending on the detected instantaneous current I_inst, and
   in an initial screwing step, adjusting the rotation speed RPM of motor 3 to an initial speed value RPM_init,
   in a final screwing step in which the detected instantaneous current I_inst increases until it reaches the target current value I_tgt, reducing the rotation speed RPM of motor 3 to a final speed value RPM_final lower than the initial speed value RPM_init.

The advantages of the control method are the same described with reference to wrench 1.

### Description of the Rotation Speed Control RPM of Motor 3

According to an embodiment, the electronic control system 7 (or more generally, the control method) adjusts the rotation speed RPM of the electric motor 3 according to a control function characterized by a bijective relationship between the detected instantaneous current I_inst and the rotation speed RPM required by the electric motor 3.

According to an embodiment, the control function requires the rotation speed RPM of motor 3 to decrease as the detected instantaneous current I_ins increases, without however inverting the rotation direction.

According to an embodiment (FIGS. 8, 9), the control function expresses the rotation speed RPM of motor 3 as a continuous (not necessarily linear) function of the detected instantaneous current I_inst, where said continuous function has a negative slope, and
a maximum rotation speed value RPM_max corresponds to the zero detected instantaneous current I_ist,
the final rotation speed value RPM_final corresponds to the target current value I_tgt and therefore, to a condition immediately before the deactivation and/or stop condition of motor 3.

Thereby, the control function requires—under the (ideal) condition in which the absorption of current of motor 3 is zero (0 A)—motor 3 to rotate at the highest speed possible, while when the target torque value M_tgt is reached, the rotation speed RPM of the motor corresponds to the final rotation speed RPM_final which is sufficiently low to keep the undesired inertial effects within tolerable limits.

According to a preferred embodiment (FIGS. 8, 9), the control function expresses the rotation speed RPM of motor 3 as a linear function of the detected instantaneous current (I_ist), with negative slope, for example in the form:

RPM=RPM_init+K×I_inst

where the slope coefficient K can take the value (RPM_final-RPM_max)/(I_tgt), where RPM_max is a maximum rotation speed value ordered to the motor when the detected instantaneous current I_ist is zero, where RPM_final is the final rotation speed value at which the electric motor reaches the target current value I_tgt, and therefore, the deactivation and/or stop condition.

According to an embodiment, the maximum rotation speed RPM_max is a theoretical value (i.e. 8000 rpm) higher than the unloaded motor 3 speed, as defined by the manufacturing specifications of the motor, and therefore that in practice cannot be reached.

The technical effect of this is to run the electric motor 3 at its maximum possible speed, until the actual rotation speed of the motor remains lower than the rotation speed RPM associated by the control function with the detected instantaneous electric current I_inst. Thereby, a lowering of the rotation speed RPM of motor 3 occurs only in a final screwing step when the screwing torque M increases significantly (FIGS. 10, 11).

FIGS. 10, 11 show how the actual rotation speed of motor 3 (middle graph) appears:
an initial ramp of increase of the rotation speed, up to the actually reached initial speed value RPM_init (in this step, the rotation speed RPM according to the control function is greater than the rotation speed actually reachable by motor 3),
a subsequent plateau in which the rotation speed RPM of motor 3 is substantially or approximately constant (in this step, the rotation speed RPM according to the control function could be even greater than the rotation speed actually reachable by motor 3 or the detected instantaneous current I_ist is still substantially constant but the actual rotation speed of the motor corresponds to the required rotation speed according to the instantaneous current I_ist according to the control function),
a final descent of rotation speed reduction up to the final speed value RPM_final (in this step, the actual rotation speed of the motor corresponds to the required rotation speed according to the control function).

According to embodiments, the method and the wrench can use or include one control function alone for all the screwing operations or a plurality of different control functions for a plurality of different screwing modes.

In the examples in FIGS. 8, 9, the maximum rotation speed value RPM_max can be, for example, in the range from 6000 rpm to 10000 rpm, the final rotation speed value RPM_final can be, for example, in the range from 1000 rpm to 3000 rpm, and the target current value I_tgt can be, for example, in the range from 30 A to 60 A.

According to embodiments, the final rotation speed value RPM_final of motor 3 is selected in the range between 1500 rpm and 2500 rpm.

According to embodiments, the final rotation speed value RPM_final of motor 3 is selected in the range between 20% and 45%, preferably between 25% and 40%, even more preferably 33% of the actual maximum rotation speed of the motor during a screwing operation.

According to embodiments, the target torque value M_tgt can be set or selected by a user through a user interface 10 of the electronic control system 7, for example a display with a pushbutton panel.

The selection of the target torque value M_tgt can include the selection of a numerical value, for example “250 Nm”, or the selection of a predefined type of rail connectors with which a predefined target torque value M_tgt is associated, for example based on technical legislation or requirements of the rail connector manufacturers. Examples of rail connectors (rail fastening systems) are Voestalpine® ERL-P®, System Rheinfeder (RF)®, Vossloh (W, W-Tram, SKL)®, Pandrol e-Clip®, FastClip®, NABLA®.

According to an embodiment, the calibration association is generated by creating a continuous, or discrete, association function for progressive pairs of torque M-electric current I values. For example, the movement of the tool holder shaft 2 with respect to the wrench structure is slowed down (without stopping it) by multiple different braking torque values, and the braking torque and corresponding current value I absorbed by motor 3 for overcoming the braking torque and rotating the tool holder shaft 3 are measured and associated with each other.

FIG. 7 shows an example of calibration association which can correspond to a table of pairs of torque M-electric current I values with the possibility of interpolating pairs of intermediate M and I values.

The control system 7 ends the screwing operation automatically depending on the detected instantaneous electric current I_inst of motor 3 and the target current value I_tgt. When the detected instantaneous current I_inst reaches or exceeds the target current value I_tgt, the control system 7 ends the screwing operation by stopping and/or switching OFF the electric motor 3.

In each operation step, the control system 7 compares the instantaneous current I_inst of motor 3 with a higher alarm current value I_alert, which when reached, stops motor 3 and emits an error warning.

An unscrewing operation does not provide any selection of a target torque value M_tgt. Upon activation of the actuation device 5, 5′, for example by pressing, the control system 7 requires the acceleration of motor 3 to the unscrewing speed and keeps it substantially constant, monitoring the current absorbed. The unscrewing operation continues until the actuation member 5 is released.

### Description of Parameter Selection

According to an embodiment, the control system 7 includes a user interface 10, for example a pushbutton panel with a display, which allows selecting or setting the operation parameter values of the wrench, by a two-level selection input, where a first input level includes the selection of the operation parameter among a plurality of different operation parameters, and a second input level includes the selection or setting of a value of the selected operation parameter among a plurality of different parameter values.

The selectable operation parameters include two or more of:
the type of rail connector to be screwed W, N, K, KS or a corresponding target torque value M_tgt (shown in FIG. 13A),
the screwing sequence SSSS, FFFF, SSFF, SFSF, FREE of a series of screwing operations (shown in FIG. 14A),
the option to generate a log file of the screwing/unscrewing operations (shown in FIG. 15A),
the display of the total number of screwing/unscrewing operations performed and/or a partial number of screwing/unscrewing operations performed starting from a reset that can be performed by the user (shown in FIG. 16),
   the display of the total number of operation hours and minutes of wrench 1 and/or a partial number of operation hours and minutes of wrench 1 starting from a reset that can be performed by the user (shown in FIG. 17),
   the brightness of the display (shown in FIG. 18A),
   data download onto external memory support, for example a USB flash drive (shown in FIG. 19A),
   display and adjustment of date and time (shown in FIG. 20).

The values of the settable or selectable operation parameters include, for example:
a plurality of rail connector codes or symbols W, N, K, KS or a plurality of numerical torque values as values for the type of rail connector to be screwed or for the target torque value M_tgt (FIG. 13B), and/or
a plurality of different screwing sequences SSSS, FFFF, SSFF, SFSF, FREE as value for the screwing sequences, (FIG. 14B), and/or
YES and NO as value for the parameter for generating a log file of the screwing/unscrewing operations (FIG. 15B), and/or
initializing at zero as value of the partial number of performed screwing/unscrewing operations (FIG. 16),
initializing at zero as value of the partial number of operation hours and minutes of wrench 1 (FIG. 17),
an “intense brightness” symbol and a “less intense brightness” symbol as values or limit adjustment values for the adjustable brightness of the display (FIG. 18B), and/or
a download symbol as value for the download parameter of data onto the external memory support (FIG. 19B).

According to an embodiment, the selection of the operation parameters and the selection or setting of the values of the operation parameters is assisted by a visualization by a display.

According to an advantageous, particularly ergonomic embodiment, the user interface 10 includes one rotating knob 11 alone and is responsive to both the rotation and pressing of the knob, where:
the selection of the operation parameter in the first input level occurs by rotating knob 11,
the transition from the selection of the operation parameter to the second input level for the selection or setting of a parameter value occurs by pressing knob 11,
the selection of the operation parameter value in the second input level occurs again by rotating knob 11 or, in the case of a selection between only two different values, by the same pressing of knob 11,
the confirmation of the selected or set parameter value in the second input level occurs by pressing knob 11.

Advantageously, the user interface 10 display a default or “home” view (FIG. 12) containing a plurality of actually set operation parameter values.

The setting of the screwing sequence SSSS, FFFF, SSFF, SFSF, FREE is advantageous due to the association of the log file execution data or execution report with the rail connector respectively screwed. Moreover, if the prescribed target screwing torques M_tgt were different on the outer side (field side) and on the inner side (track side) of the rail, the setting of the execution sequence (or first all the rail connectors track side or first all the rail connectors field side or zigzag track size-field side-track side, etc.) allows automatically adapting the applicable target torque value M_tgt.

The rotating knob 11 can be associated with a Hall sensor for generating a selection signal by rotating the knob and with a magnetic proximity sensor for generating a distinct selection signal by pressing knob 11.

### REFERENCE SIGNS

wrench 1
tool holder shaft 2
bushing 2
electric motor 3
battery 4
actuation and direction selection device 5, 5′, 9
manual screwing actuation member 5
manual unscrewing actuation member 5′
reducer 6
electronic control system 7
memory 8
direction selector 9
user interface 10
rotating knob 11
lighting members 12
reaction arm 13
front side F
rear side P
rotation axis R
electric current I absorbed by the motor
detected instantaneous current I_inst
target current value I_tgt
higher alarm current value I_alert
torque M applied by the wrench
target torque value M_tgt
motor rotation speed RPM
initial speed value RPM_init
final speed value RPM_final
maximum rotation speed value RPM_max
time t

1-14. (canceled)

15. A wrench, comprising:
a tool holder shaft,
an electric motor powered by at least one electric battery,
a reducer connected between the motor and the tool holder shaft,
an electronic control system connected to the electric battery and the electric motor, wherein the electronic control system comprises:
an actuation and direction selection device for actuating the motor and for selecting the rotation direction of the tool holder shaft,
a memory wherein a calibration association between a screwing torque of the wrench and a corresponding electric current absorbed by the motor is stored,
wherein the electronic control system is configured for:
detecting an instantaneous current of the motor during its operation,
detecting an actuation state of the actuation and direction selection device,
controlling a power supply of the electric motor depending on the detected actuation state, on the selected rotation direction, on a target torque screwing value, on the detected instantaneous current and on the stored calibration association,
if the selected rotation direction is a screwing direction:
when the detected instantaneous current reaches or exceeds a target current value corresponding to the target torque value according to the calibration association, deactivate and/or stop the motor,
change a rotation speed of the motor depending on the detected instantaneous current, and
in an initial screwing step, adjust the rotation speed of the motor to an initial speed value,
in a final screwing step, wherein the detected instantaneous current increases until it reaches the target current value, reduce the rotation speed of the motor to a final speed value lower than the initial speed value.

16. The wrench of claim 15, wherein the electronic control system adjusts, at least in a final screwing step, the rotation speed of the electric motor according to a control function characterized by a bijective relationship between the detected instantaneous current and the rotation speed imposed to the electric motor.

17. The wrench of claim 16, wherein the control function imposes that the rotation speed of the motor decreases as the detected instantaneous current increases.

18. The wrench of claim 16, wherein the control function expresses the rotation speed of the motor as a continuous function of the detected instantaneous current, wherein:
said continuous function has a negative slope, and
a maximum rotation speed value corresponds to zero detected instantaneous current,
the final rotation speed value corresponds to the target current value and, therefore, to a condition immediately before the deactivation and/or stop condition of the motor.

19. The wrench of claim 16, wherein the control function expresses the rotation speed of the motor as a linear function of the detected instantaneous current, with negative slope, in the form of:
$$RPM = RPM\_init + K \times I\_inst$$
wherein:
the slope coefficient K has a value of (RPM_final−RPM max)/(I_tgt),
RPM_max is a maximum rotation speed value dictated to the motor in case of zero detected instantaneous current (I_ist),
RPM_final is the final rotation speed value at which the electric motor reaches the target current value (I_tgt).

20. The wrench of claim 18, wherein the maximum rotation speed is a theoretical value higher than the unloaded motor speed, as defined by the building specifications of the motor, and therefore that cannot be reached in practice, in such a way to run the electric motor at its maximum possible speed, until the actual rotation speed of the motor remains lower than the rotation speed associated by the control function to the detected temporary electric current.

21. The wrench of claim 15, wherein during a screwing operation the rotation speed of the motor, plotted against time, displays:
an initial ramp of increase of the rotation speed, up to the actually reached initial speed value,
a subsequent plateau wherein the rotation speed of the motor is essentially constant,
a final rotation speed reduction to the final speed value.

22. The wrench of claim 18, wherein the maximum rotation speed value ranges between 6000 rpm and 9000 rpm, the final rotation speed value ranges between 1500 rpm and 2500 rpm.

23. The wrench of claim 15, wherein the final rotation speed value of the motor ranges between 20% and 45%, or between 25% and 40%, or it is 33% of an actual maximum rotation speed of the motor during a screwing operation.

24. The wrench of claim 15, wherein the target torque value can be set or selected by a user through a user interface of the electronic control system, and
the selection of the target torque value includes:
selection of a numerical value and/or selection of a predefined type of rail connector to which a predefined target torque value is associated.

25. The wrench of claim 15, wherein the control system includes a user interface with a display, that allows a selection of operation parameter values of the wrench, by means of a two-level selection input, wherein:
a first input level includes the selection of the operation parameter among a plurality of different operation parameters, and
a second input level includes the selection of a value of the selected operation parameter, among a plurality of different parameter values.

26. The wrench of claim 25, wherein the selectable operation parameters comprise two or more of:
type of rail connector to be screwed or corresponding target torque value,
screwing sequence of a series of screwing operations, generation of a log file of the screwing operations, display of a total number of the screwing operations performed and/or of a partial number of the screwing operations performed starting from a reset that can be performed by the user,
display of a total operation time of the wrench and/or of a partial operation number of the wrench starting from a reset that can be performed by the user,
a display brightness,
data download on external memory support,
display of date and time.

27. The wrench of claim 25, wherein the user interface includes a rotating knob responsive both to the rotation and the pressure of the knob, wherein:
the selection of the operation parameter in the first input level occurs by rotating the knob,
the switching from the selection of the operation parameter to the second input level for the selection or setting of a parameter value occurs by pressing the knob,
the selection of the operation parameter value in the second input level occurs again by rotating the knob, the confirmation of the selected parameter value in the second input level occurs by pressing the knob.

28. A method for controlling a wrench, comprising the steps:
arranging a calibration association between the screwing torque and a corresponding electric current absorbed by a motor of the wrench,
actuating the motor of the wrench and selecting a rotation direction of a tool holder shaft of the wrench,
detecting an instantaneous current of the motor during its operation,
controlling the power supply of the electric motor depending on the selected rotation direction, on a target screwing torque value, on the detected instantaneous current, and on the calibration association,
if the selected rotation direction is a screwing direction:
when the detected instantaneous current reaches or exceeds the target current value corresponding to the target torque value according to the calibration association, deactivate and/or stop the motor,
change a rotation speed of the motor depending on the detected instantaneous current, and
in an initial screwing step, adjust the rotation speed of the motor to an initial speed value,
in a final screwing step wherein the detected instantaneous current increases until it reaches the target current value, reduce the rotation speed of the motor to a final speed value lower than the initial speed value.
